(19) United States
(12) Patent Application Publication
(10) Pub. No.: US 2011/0055017 A1
(43) Pub. Date: Mar. 3, 2011

(54) SYSTEM AND METHOD FOR SEMANTIC BASED ADVERTISING ON SOCIAL NETWORKING PLATFORMS

(76) Inventors: Amiad SOLOMON, The Bronx, NY (US); Moshe Koppel, Efrat (IL); Jonathan Schler, Petach Tikva (IL)

(21) Appl. No.: 12/873,051

(22) Filed: Aug. 31, 2010

Related U.S. Application Data
(60) Provisional application No. 61/238,709, filed on Sep. 1, 2009.

(51) Int. Cl. G06Q 30/00

(52) U.S. Cl. 705/14.66

(57) ABSTRACT

A system and method for semantic based advertising is provided. Information related to a social network may be obtained. Analysis of collected information may be performed to produce an analysis result. An advertisement may be selected based on the analysis result. Other embodiments are described and claimed.

### CROSS REFERENCE TO RELATED APPLICATIONS

This application claims the benefit of U.S. Provisional Application No. 61/238,709, filed on Sep. 1, 2009, which is incorporated in its entirety herein by reference.

### BACKGROUND OF THE INVENTION

Various methods and systems for advertising over the Internet exist today. The development of computing devices and/or their ability to communicate has made new advertising methods and systems possible. These systems may employ contextual analysis of various information in order to target users. Yet other systems use cookies in order to track users and provide users with advertising material based on information exchanged by cookies.

Recent times have seen the advent of social network sites, such as myspace, Facebook, LinkedIn and others. There is a need for Internet advertising directed to such websites in particular, taking into account their unique properties, without violating terms of use or intruding on user's privacy concerns.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows an exemplary network system according to embodiments of the invention;

FIG. 2 shows an exemplary screenshot according to embodiments of the invention;

FIG. 3 shows an exemplary screenshot according to embodiments of the invention;

FIG. 4 shows an exemplary screenshot according to embodiments of the invention;

FIG. 5 shows an exemplary flowchart that may be used for semantic based advertising according to embodiments of the invention; and

FIG. 6 shows an exemplary computing device according to embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

Embodiments of the invention may be applicable to a variety of systems or platforms, for example, social related platform such as Twitter, myspace, Facebook, LinkedIn, or other social networks or related platform, e.g., electronic mail (email) systems such as gmail or hotmail, which incorporate some social networking features. Any system, device, application or platform that may be used by a number of users in order to communicate with each other (as a whole or in subsets), particularly in realtime, may be applicable, may implement embodiments of the invention. Such systems, applications or platforms may be collectively or generally referred to herein as social networks. For the sake of simplicity, applicable platforms will be referred to herein as “social networks”. As discussed below, one particularly useful feature for purposes of the present invention may be the posting or “status” feature included in a large number of social network sites, which permits users to broadcast or multicast substantially realtime information about their immediate past, present or intended future activities to subscribers, followers, friends, etc.

Embodiments of the invention may enable providing to a processor digital information generated by a user associated with a social network, semantically analyzing, by the processor, the digital information to produce an analysis result, selecting an advertisement based on the analysis result and providing the selected advertisement to the user and/or to other users, e.g., members of a related social network.

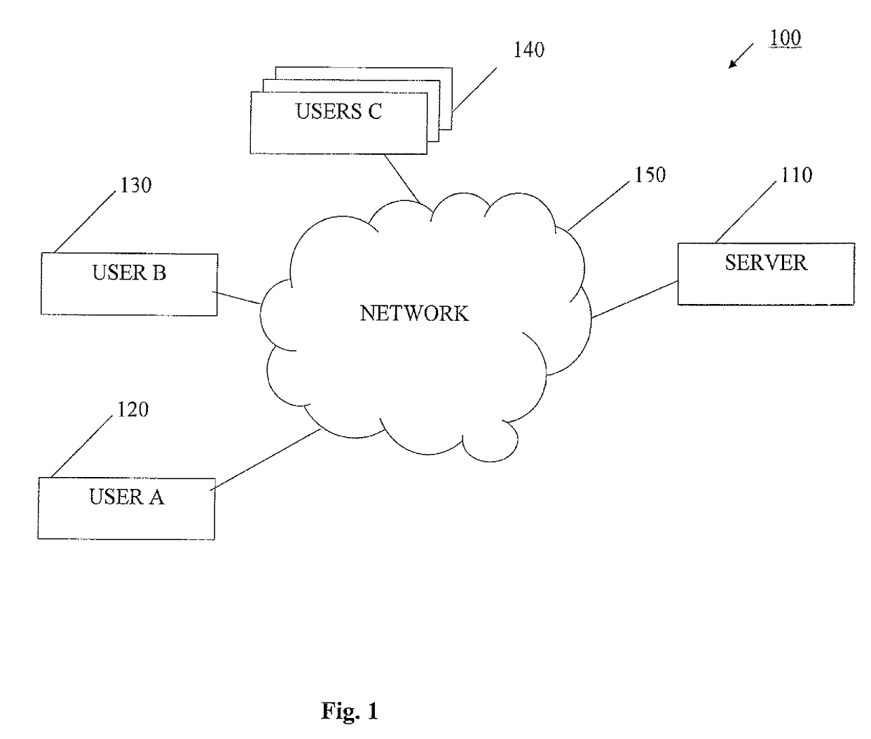

Reference is made to FIG. 1, showing a schematic view of an exemplary system 100 according to embodiments of the invention. System 100 may include a server 110, a user A 120, a user B 130, a plurality of users C 140 and a network 150 for communication therebetween. For the sake of simplicity, computing devices operated by users A, B and C are not particularly shown, however, it will be recognized that users A, B and C as referred to herein denote a user operating any applicable computing device. For example, users A, B and C may operate a personal computer, a desktop computer, a mobile computer or phone, a smartphone, a laptop computer, a notebook computer, a terminal, a workstation, a server computer, a personal digital assistant (PDA) device, a tablet computer, a wired or wireless network or communication device, or any other suitable computing device. Server 110 may be any applicable server platform, e.g., one or more server computers or any one or more of the devices described herein with reference to devices that may be operated by user A. Server 110 may include hardware, software, firmware modules, or a combination thereof. It will be recognized that embodiments of the invention are not limited by the type or nature of server 110 and/or devices operated by users A, B and C.

Network 150 may be, may comprise or may be part of a private internet protocol (IP) network, the internet, an integrated services digital network (ISDN), frame relay connections, modem connected to a phone line a public switched telephone network (PSTN), a public or private data network, a local area network (LAN), a metropolitan area network (MAN), a wide area network (WAN), a wireline or wireless network, a local, regional, or global communication network, an enterprise intranet, any combination of the preceding and/or any other suitable communication means. Network 150 may also or in addition, be, comprise or be part of a wireless network, e.g., a global system for mobile communications (GSM) network. For example, network 150 may include or comprise an IP network such as the internet, a GSM related network and any equipment for bridging or otherwise connecting such networks as known in the art. It will be recognized that embodiments of the invention are not limited by the nature of network 150.

In some embodiments, server 110 may be a web server and may provide web pages to users A, B and C. Users A, B and C may interact with server 110 and/or with each other by interacting with web pages provided by server 110, e.g., as known in the art with respect to social networks. Accordingly, an application (not shown) on server 110 may collect various information, parameters or data originating from or destined to users A, B and C. For example, a hardware unit, a firmware module or a software application and/or some combination thereof, may be associated with a web server application and may receive or otherwise obtain any relevant information exchanged with or by users or communicated to/from users A, B and C.

Such module, unit or application may further analyze or otherwise process information, parameters or data collected as described herein. Such module or application may further select an advertisement and serve the selected advertisement to one or more users. Alternatively or additionally, a number of modules or applications may be used. For example, a first module, unit, component or application may collect data as described herein, a second module may process collected and other data while a third module, e.g., an advertisement server or application thereon, may select an advertisement based on the analysis or processing of the collected or other data and may further deliver a selected advertisement to a user. Alternatively or additionally, data may be collected and/or processed on devices operated by users A, B and C. For example, a software module (not shown) installed on a device operated by user A may be associated with a web browser and may collect any relevant data or parameters and further communicate data to an application on server 110. Any advertisement delivery system as known in the art may be used by embodiments of the invention after an advertisement has been selected for delivery. In some embodiments, an advertisement server may further select a specific advertisement from a plurality of advertisements based on parameters provided by embodiments of the invention. For example, a module on server 110 described herein may semantically or otherwise analyze communications or interactions such as posts, status updates, emails or other communications or events related to a social network. Such analysis may determine or identify various behavioral aspects of users. Such behavioral or other computed parameters may be used to select a type of advertisement to be delivered to a predefined set of users. The module may serve an advertisement server with a type selection and leave the selection of the specific advertisement to the advertisement server. Such configuration may enable providing a variety of advertisements based on a single selection.

Data collected as described herein, including, for example, from communications or interactions such as emails, posts or status updates, may be analyzed, either standing alone, or in light of other information, as described below. According to embodiments of the invention, based on analysis or other processing of actions, communications, social relations and/or other social aspect, advertising content may be served, possibly in realtime. Any applicable analysis may be employed by embodiments of the invention. For example, text analysis, word spotting or word combinations analysis may be performed. Other relevant analyses may be analysis of multimedia content or behavioral or contextual analyses as known in the art. In some embodiments of the invention, semantic analysis of temporal user information related to communications or interactions such in social networks such as status updates, posts, chat, email etc. may be used alone. However, it will be understood that in some embodiments of the invention, such semantic analysis may be combined with other information, such as data or analysis from other sources, e.g., behavioral targeting, contextual, demographic information, etc., for example, to refine or disambiguate the advertisement selection.

In some embodiments of the invention, some background information about the user may be known based on the user's biographical information (e.g., age, gender, residence, etc.), or interests or associations (e.g., by group memberships, etc.) This information may be used together with realtime information, e.g., posts or status updates, to narrow or disambiguate the parameters or categories of advertisements to be selected.

For example, such information may be stored in a profile. Embodiments of the invention may create, update, maintain and use profiles. As described herein, various profiles related to various entities may be employed by embodiments of the invention. For example, temporal, dynamic and/or long term user profiles may be used as described herein. Profiles may be maintained for groups, social networks, or any defined number of users. Generally, a temporal or dynamic profile may reflect recent, up-to-date or realtime aspects of a user, group or network. A long term or static profile may reflect long term aspects. For example, a temporal or realtime profile may reflect activities a user is currently engaged with while a long term profile may reflect fields of interest.

Any data or aspects of data may be processed or analyzed. For example, analysis of communications or interactions such as posts, status updates, chat text, emails or other text generated by users may include identifying a language style or usage. A language style may include any related aspects, e.g., terms used, structure of sentences, length of sentences or any other identifiable patterns, structures or other linguistic elements. A language style may be used in various ways. A users profile may include, in addition to parameters, data and information described herein, an indication of a language style or usage of the user. Users may be identified, associated, selected, viewed or otherwise treated based on a language style or usage. For example, it may be the case where a specific language style is shared by users who share other aspects or parameters. For example, users from a specific geographical region may share the same language style, students in a specific university may share another language style. Accordingly, embodiments of the invention may base a selection of content for delivery on a language style of users, groups or networks. For example, a group of users may receive similar advertisements based on a similar or common language style. As further described herein, selecting content to be delivered to a group or number of users may be based on any applicable information. These methods can therefore be used to augment user-provided demographic data, or standing alone when user-provided demographic information is unavailable or unreliable.

In some embodiments, semantic analysis may be used. For example, semantic analysis of an entire page of a social network may be performed, for example, including posts or status updates received from social network friends. For example, when analyzing a web page related to a Facebook™ account, content from the web page, including content by group memberships or friends may be processed, analyzed and/or used. In another example, layout, e.g., particular applications that a user has running on the social network platform may be used. Other available information may be related hypertext markup language (HTML) code or any other parameters or relevant data. For example, a module executed on server 110 as described herein may be provided with such data or parameters. Semantic analysis of a web page may analyze some or all elements in the page. Such analysis may take into account any graphical or other object displayed on the page as well as user interactions with any of the elements. For example, if a news flash window is opened by the user, then current political, social or economical events may be taken into account by the analysis process. Another example may be a game being currently played by a user, wherein such game being played may be relevant to a selection of an advertisement to be served. Semantic analysis may further take into account any relevant information. For example, politics, stock market, news, popular TV shows may all be relevant. For example, when a new movie comes out, detecting a name of an actor in such movie, e.g., in an email, a post or status update may cause an advertisement for a movie or DVD starring that actor to be served. A topic appearing in the news may be identified as such in a post, such identification may enable embodiments of the invention to deliver relevant, up to date advertisements, possibly in real time.

It will be recognized that semantic analysis may be performed as known, or as described, for example, in U.S. Pat. No. 7,302,404, U.S. patent application Ser. No. 12/347,027, or in U.S. Provisional Patent Applications No. 61/006,221, 61/071,707, 61/115,562, 61/115,564.

Any data, parameters or other information from various sources may be combined, processed and analyzed. For example, analysis of text generated by a user may be based on the user's demographic data. For example, text related to the user may be analyzed based on a user's address or nationality, possibly taking into account aspects such as a language style of the country or region. Other aspects, e.g., games the user plays, friends, type of activities or any other obtainable information related to the user may all be combined by embodiments of the invention in profiling a user. Such profiling may be reflected in a profile maintained for specific users, groups and/or social networks.

Semantic or other analysis of information may be presented to an advertiser, publisher or other entities. For example, semantic or other analysis of information in a web page related to a social network may be according to a number of predefined categories or filters. For example, a demographic filter, criteria or category may enable analyzing, displaying and/or targeting various groups of users, e.g., females only, residents of California only etc. Likewise, a semantic filter may select users related to a specific field of interest, e.g., sports or art. An “in the market for” category or criteria may define a plurality of sub-categories or filters enabling to select users who are interested or engaged in purchasing a specific product or service or engaged in a specific activity. Analysis of information presented to, received or exchanged by users may enable categorizing users as described herein. For example, based on analyzing communications or interactions such as emails, posts or status updates, users fields of interests, activities, planned activities, other plans or other behavioral aspects may be identified, deduced or determined. Accordingly, categories, criteria or filters described herein may be applied and may further enable selecting and targeting specific users by their association with categories or criteria.

Information communicated over social networks is different from the information communicated over other platforms. For example, the information users exchange over platforms such as Facebook™, twitter or other social networks is different from that exchanged over typical web pages. For example, a typical social network platform enables users to provide each other with status updates. By providing status updates, a user may inform or update friends or others regarding his or her activities, plans or related events. Accordingly, by obtaining information included in communications or interactions such as emails, status updates, posts or other social networking related communications, an advertisement may be selected according to a past, present, or intended future activity or event of a user. For example, a user may inform friends she is about to go shopping, look for a house or fix the car. By tracking and/or analyzing status updates used by the user, embodiments of the invention may identify and/or determine users activities, interests, plans or other relevant aspects. Accordingly, advertisements may be selected based on users plans, activities, interests or other relevant aspects.

Posts as known in the art and specifically in social networks, may be analyzed by embodiments of the invention. Analysis of posts over a social network may enable embodiments of the invention to identify and/or determine users activities, interests, fields of interests, plans or other relevant aspects. For example, determining a user is inviting another user to come for a visit may cause embodiments of the invention to display an advertisement for a taxi service or an air ticket, for example, based on the respective locations of the users. In some embodiments, an advertisement may be selected based on a field of interest. For example, by identifying subjects or topics in posts embodiments of the invention may determine a user's post or status update together with a field of interest. For example, word spotting or word combination analysis may be used to identify subjects or topics related to posts, status updates or emails. Accordingly, advertisements may be selected according to such field of interest. According to embodiments of the invention, advertisements may be served in real time. For example, upon detecting a relevant word, issue, topic, subject or activity, e.g., by analyzing an email, a post or a status update, a relevant advertisement may immediately be delivered to one or more users as described herein.

In some embodiments, semantic or contextual analysis of users communications may be performed. For example, semantic analysis of emails, status updates or posts may be performed. For example, the terms “eat” or “lunch” in a post to a friend may be viewed or interpreted in one way while the same terms detected in a status update may be interpreted in another way. For example, the phrase “going out for lunch” in a post to a friend may cause embodiments of the invention to select advertisements related to restaurants while the phrase “having lunch in the office”, when detected in a status update, may cause selecting an advertisement for a takeaway place.

Other information available to the system may be used, for example, from what computing device the user is updating status. Thus, a different advertisement may come up for a status update provided from a home computer as opposed to a mobile computing device, e.g., mobile phone.

Another example of information that may be used is entries and exits from the social network. A social networking site may be able to identify a link from which a user enters the site, e.g., from an email message, an advertisement placed on a particular website, etc. Moreover, the social networking site may identify an exit site to which the user may leave, for example, by way of an external link from the website. Accordingly, these entry and exit points for each user may be used as temporal information to identify present interests, activities, and other features of the user profile, and may further be used to select and advertisement to be served to the user. For example, information that a user entered a social networking site via a link from a magazine may prompt the user with an advertisement from an associated publication or a relevant product.

In some embodiments, various social groups or group activities may be identified, and an advertisement provided to the entire group or a subset thereof, based on a status update of a single member of the group. For example, user social relations, social circles or friends may be identified. Embodiments of the invention may use social network related information in order to select advertising content for delivery. Advertising content may be selected and served to users based on processing of such information, parameters or data. According to embodiments, a repository, e.g., a database may store any relevant information. A module or component collecting and/or analyzing data as described herein and/or selecting advertisements as described herein may receive or otherwise obtain any required data from such repository. For example, a database (not shown) may be operatively connected to server 110. Accordingly, a module described herein may query such database for any applicable information, parameters or data. For example, such database may store users profiles or other data reflecting, among other parameters, a user's social community, identity of the user's friends, a user interest fields, e.g., based on posts (or other communications or interactions such as emails or status updates), a users activity history, e.g., based on status updates etc. Any social aspects may be reflected in a user profile that may be updated, possibly in real time and may further be applicable to a predefined historical and/or future time period. A user's profile may be updated in real time. For example, the database described herein may be updated, for example by a module in server 110. Updating a user's or group's profile may be done so that any relevant changes in applicable parameters or aspects are reflected in the updated profile. For example, if a user begins to show interest in a specific television show then the relevant profile may be updated in order to reflect such change in fields of interest. Likewise, a group of users may be associated with a profile reflecting common parameters, e.g., common fields of interest, places the group meets, dines etc.

In some embodiments of the invention, a profile may be generated for, or otherwise associated with a social group based on social network temporal information of one or more members of the group. A group may be dynamically or otherwise defined according to any applicable criteria. For example, a group may be all users designated as “friends” of a user by a social network or a group may be defined by geographical parameters, interest, memberships, etc. Accordingly, an advertisement may be selected based on aspects or parameters related to a group. Such advertisement may further be delivered to some or all members of the group. For example, determining a user is inviting another user to watch the football game may cause embodiments of the invention to deliver an advertisement for pizza or beer to both users. Possibly based on a information or a parameter indicating these two users often meet, a selection of an advertisement may be made. Furthermore, based, for example, on text exchanged in posts (or in other communications or interactions such as emails or status updates) between a group of users, aspects related to the group of users may be identified or determined. For example, places where members of a group usually meet, food they eat, sport events they attend and the like. Accordingly, relevant targeted advertisements may be delivered to some or all members of the group. Such delivery may further be coordinated in time, e.g., the same or similar advertisement may be served to all members of a group at the same time. For example, assuming user A 120, user B 130 and users C 140 are identified as a group, detecting the term “play” or “game” in a post from user A 120 to user B 130 may cause embodiments of the invention to deliver an advertisement for a soft drink to user A 120, user B 130 and users C 140.

Generalizing this example, semantic analysis of social network information about one user (or a subset of users in a group) may be used to understand and select advertisements for other members of the group, for example, based on common interests or activities. This feature may be particularly useful to analyze a user's friends or individuals in a social network having similar semantic profiles. In some embodiments of the invention semantic profiles of the networks of each user on a network may be analyzed, and correlations may be found that may disclose information about the user. In some embodiments of the invention, selection of advertisements for users on a first social networking site having certain semantic profiles may be affected or augmented by information obtained from users on a second social networking site having similar semantic profiles. Likewise, selection of advertisements or other content to be provided to a first user having certain semantic profiles may be affected or augmented by determined or observed similarities to a second user's profile, behavior, posts or status updates (or other applicable communications or interactions as described herein).

A profile may be used or otherwise relevant in various ways. For example, based on a user's profile relevant networks may be identified and possibly associated with the user. Accordingly, parameters or aspects relevant to delivering or serving content to associated networks may be relevant to such user. Based on a user's profile, various parameters related to an associated network may be identified, determined or computed. For example, by observing the profiles of some or all users associated with a specific network, a network profile may be generated, updated or otherwise manipulated. Similar to a group profile, a network profile may include any relevant parameters, data or information related to the network. Accordingly, a selection of content to be server may be based on a profile of a user, a group or a network or any combination thereof. For example, content may be selected to be provided to all members of a network based on the network's profile, however, a profile of one specific user may indicate that that specific user should not receive the selected content. Accordingly, embodiments of the invention may server the selected content to all members of the network except that specific user.

In some embodiments of the invention, a profile may be dynamic or it may be static. A dynamic profile may be updated according to a predefined frequency, every time a relevant event is detected or according to any policy. For example, a profile may be updated every time text from the user is processed. In other cases, possibly while data from the user is continuously processed and parameters are saved, the profile may be updated once a day. A number of profiles may be maintained for a user, group or network. For example, a first realtime, up to date profile may reflect the user in realtime while another profile may reflect historical aspects, e.g., by being updated once a day and/or averaged in order to reflect trends or other aspects related to the relevant network, group or user. Dynamic profiles may be maintained by giving greater weight to more recent updates or activities or otherwise averaging data.

A dynamic profile may be a temporal profile. A temporal profile may reflect realtime parameters or information related to the user, group or network. A temporal user profile may indicate the user is currently driving a car, taking a shower or reading a book. A temporal realtime profile of a group may indicate the group is currently having dinner or in a party. A temporal profile of a network may reflect down time, number of online users, rate of users joining and leaving the network, top topics discussed over the network etc. a temporal or realtime profile may enable a realtime selection of content to be served as discussed herein.

A profile may be generated, updated or maintained according to any point of interest. For example, a publisher, advertiser or other interested entities may require profiles to reflect specific aspects. For example, an advertiser of phones may want to know how many times a day users talk on the phone or otherwise use their phones. Accordingly, embodiments of the invention may cause user profiles to reflect the number of calls and/or duration of calls made by users. For example, by analyzing user generated text, posts or status updates it may be possible to determine phone usage and update the relevant profile accordingly. Accordingly, the interested advertiser may be provided with statistics or other information related to phone. Additionally, selection or targeting of advertising material or other content may be based on such phone usage as reflected by profiles.

Another example may be an event where user A 120 bought a product, possibly based on analysis of past communications with other members of a group, an advertisement related to the product purchased by user A 120 may be delivered to user B 130 and/or some of users C 140. A parameter indicating an affiliation, association or relationship level related to two or more users may be generated. Such parameter may be observed in order to select an advertisement to be delivered to a first user based on an event related to a second user. For example, a strong or tight association of two users may cause a similar advertisements to be delivered to both users. For example, a group of users that periodically spend a vacation together may all receive the same advertisement for the same hotel at the same time. As described herein, determining activities performed by users may be based on analysis of their social interactions over a social network.

Demographic data related to a user may be available and used in the process of selecting an advertisement, for example, such data may be retrieved from database described herein. For example, a user is inviting another user to come for a visit may cause embodiments of the invention to display, to either one or both users, an advertisement for a taxi service or an air ticket based on geographical information indicating whether the users are within a taxi ride distance from one another or within a flight distance.

Another example may be determining a user is about to go out, e.g., by analyzing a status update or post. Such information may be used, for example, to select an advertisement related to a place where the relevant users usually spend time when going out and delivering such advertisement to a predefined group of users, e.g., those identified as friends in a social network. Any other information, e.g., related to what users or groups of users have, buy, do, want, interested in or plan may be identified, analyzed, determined, collected and further used in the process of selecting advertisements to be served.

In some embodiments of the invention, users might be assigned multiple profiles, which may vary from relatively static to highly dynamic. Dynamic profiles may be based, for example, on giving greater weight to more recent updates or activities. At any given time, these dynamic profiles might reflect a user's interests or needs at that particular time. Advertisements might therefore be selected and/or served that are responsive to those particular dynamic, possibly fleeting, interests and needs.

Embodiments of the invention may enable an operator, publisher or other entities providing content and/or advertising material to manage advertising campaigns or other advertising content delivery. Embodiments of the invention may enable a semantic based behavioral targeting network. In some implementations, behavioral aspects of users, communities or groups may be identified and may further be used in order to deliver advertising or other content to users. Profiling of users, groups or communities may be performed based on analyzing user interactions and communications as described herein. Interactions analyzed may be between users or they may be between users and applications. For example, posts or status updates may be semantically analyzed as well as interactions with gaming or other applications that may be embedded in a social network platform, e.g., online games. While an operator of a social network platform may be restricted from exporting user information collected or obtained as described herein, such operator may use such information in order to launch advertising or other campaigns.

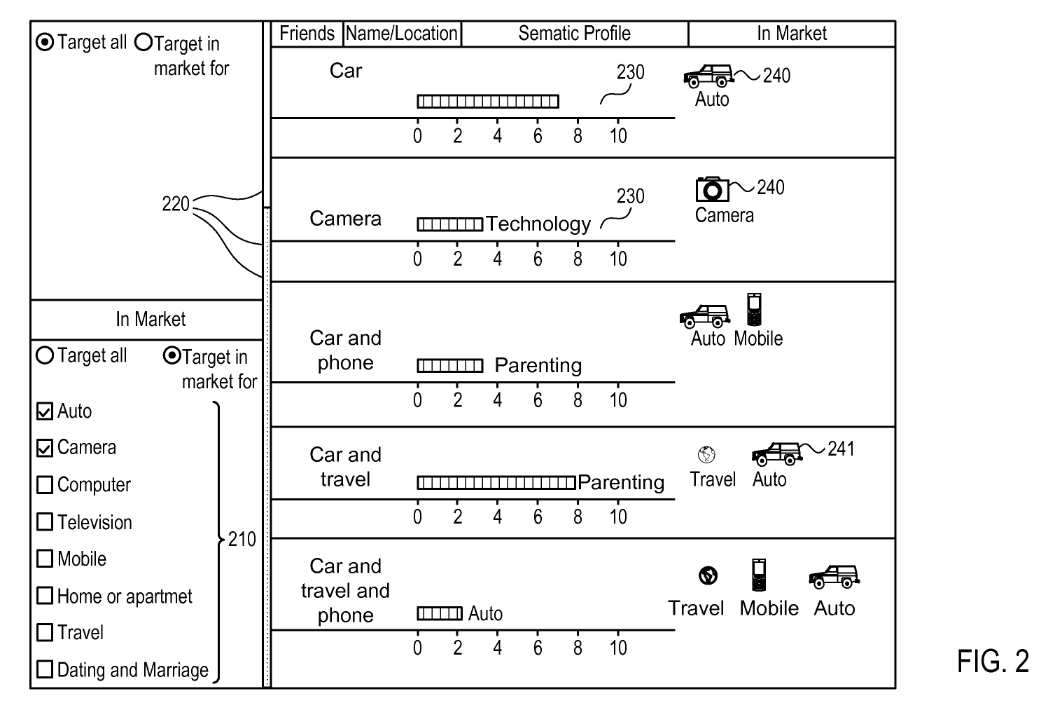

Reference is made to FIG. 2 showing an exemplary screenshot according to embodiments of the invention. As shown by FIG. 2, a summary display may be provided. A summary display may provide an operator or other relevant entity with parameters, information, data or details such as a number of users interested in a specific product or activity. An operator may select filters or categories and be provided with a summary view based on such selection. For example and as shown by 210, check boxes may be checked to add products, activities or other aspects of interest to a displayed summary. For example, by checking the appropriate boxes, a summary of users who are interested in purchasing a car, a camera or a phone may be displayed. Other criteria that may be selected may be users who are about to relocate and/or buy a house, get pregnant, get a job etc. Yet another applicable criteria may be a “recently bought” criteria, e.g., recently bought a house, a camera, a computer etc. As shown by 220, a list of categories, criteria or groups may be displayed, possibly according to a selection made. As shown by 230, a graph or bar and associated scale may provide graphic and detailed information, e.g., the number of users currently involved or interested in purchasing a car. As shown, a summary display may show the number of users interested in product for a number of products. As shown by 240, a graphical icon may enable quick and intuitive view. As shown by 241, a category may be defined for a number of products. For example and as shown by 241, a category of users interested in both traveling and buying a car may be displayed.

Embodiments of the invention may provide an operator with a semantically based behavioral view of a social network. Based on semantic or other analysis described herein, a network profile and/or view may be generated. A network view may provide a view of the entire defined network, e.g., a social network. An alternative view may be user or group specific as further described herein.

Based on information collected and analyzed as described herein and/or stored in and retrieved from a database as described herein, various views may be possible. User profiles may be created and updated, possibly in real time based on collecting or obtaining information, data and parameters related to users. A user profile may reflect relevant aspects such as field of interest, intention to buy a product or service, plan to perform an activity etc. Delivery of advertising or other content may be based on a user profile. Various filters may be applied in order to provide various views of a social network. Such filters may also be applicable in the selection and delivery of advertising or other content. For example, a specific advertisement may be delivered during a specific time of day or specific day of the week to females only based on their behavioral profile. For example, females discussing, over a social network, a makeup products or planning to go to a party may be provided with an advertisement for a makeup product. A user profile and accordingly a network profile may be dynamic, e.g., they may be dynamically updated according to activities, communications and interactions of users. For example, if a user who was never before involved in sports begins discussing, e.g., in posts on a social network, sports with friends then the profile of that user may be updated to include such new field of interest.

Although only a number of exemplary categories are shown and described herein, any number of any applicable categories, filters or criteria may be defined. For example, a “life style” criteria may be implemented. A specific “life style” parameter may be associated with a user based on the number of posts related to a specific topic or subject. A “life style” profile may be assigned a level according to the number of posts related to the topic generated by a user. Exemplary “life style” profiles or parameters may be, cooking, games, home, parenting, real estate, technology, traveling. The number of posts related to the topic as well as the number of times the topic is specifically discussed may be used to determine a level of affiliation of the user with the topic.

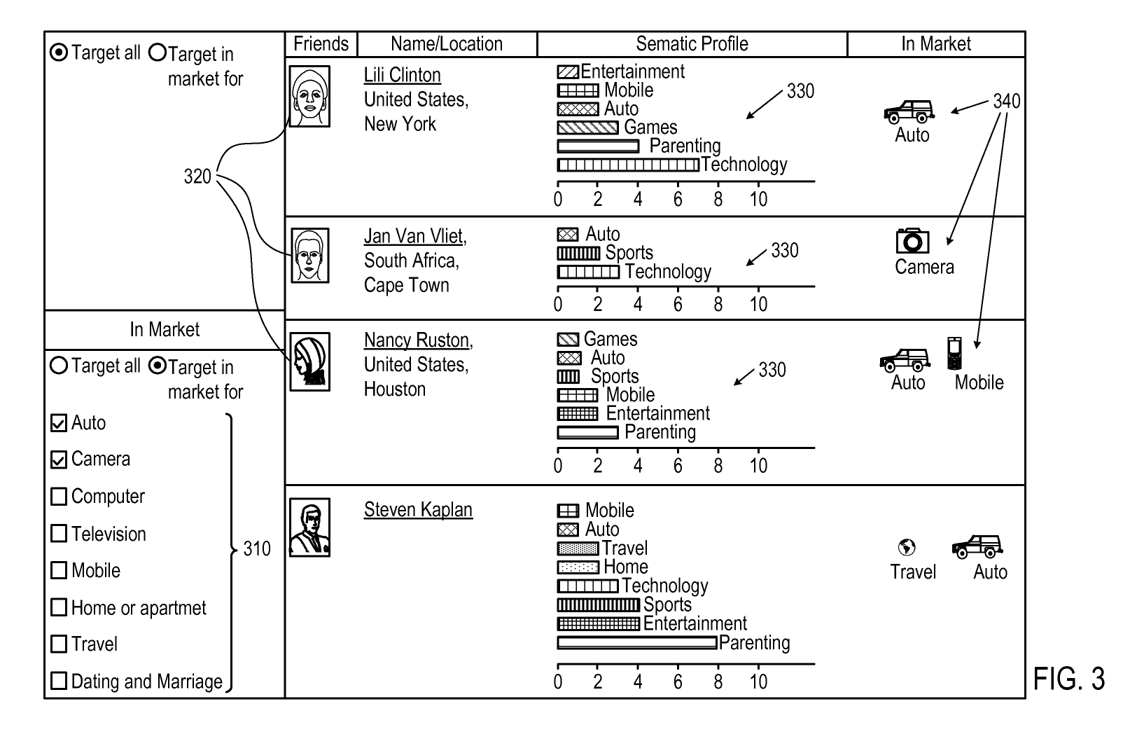

Reference is made to FIG. 3 showing an exemplary screenshot according to embodiments of the invention. As shown by FIG. 3, a drill down, specific or detailed view may be possible. For example, a per user view. According to embodiments of the invention, views or displays shown by FIGS. 2 and 3 may be dynamic. For example, such views may be updated in real time to reflect an up to date view of the social network. Accordingly, trends may be quickly and easily identified. An automatic advertisement selection process described herein may be coupled to a view of a social network. Accordingly, real time response in terms of advertising may be enabled.

In some embodiments of the invention, an operator may select filters or categories and be provided with a view based on such selection. For example and as shown by 310, check boxes may be checked to add products, activities or other aspects of interest to a view. For example, by checking the appropriate boxes, e.g., camera and/or travel, users interested in such products may be added to the view. As shown by 320, various information related to the users may be displayed. For example, content typically found or present in social networks, e.g., a photo of the user, demographic details and the like may be displayed as shown by 320.

As shown by 330, a bar chart may indicate a level of activity, interest or affiliation of a user with respect to a plurality of products, activities or other defined parameters. For example, the bar chart may indicate or show a percentage of the overall posts from the user related to a specific product. For example, separate bars per user may be related to parenting, travel, and sports. Based on analysis described herein, a profile of a user may be displayed as shown by 330 enabling visual view of the level of interest of the user in a number of products, issues or activities. The bar chart shown by 330 may be relevant to a predefined historical time period, e.g., one week or one month. A more up to date view may be possible as shown by 340. As shown by 340, an icon indicating a current interest of a user may be displayed. Such icons may be updated in real time. For example, immediately after determining a user is interested in buying a car or is actively looking to buy a car an appropriate icon, e.g., of a car, may be displayed as shown by 340. Accordingly, icons 340 may provide an up to date or real time view of potential targets for advertising content.

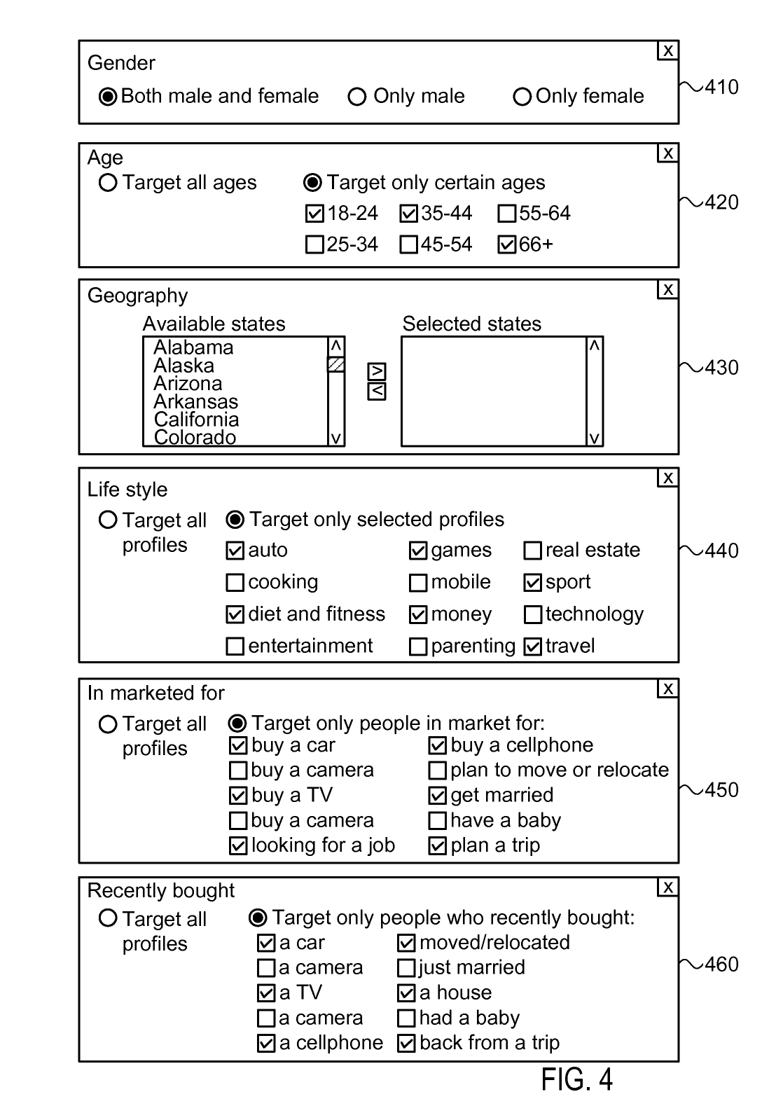

Reference is made to FIG. 4 showing an exemplary screenshot according to embodiments of the invention. As shown by FIG. 4, various parameters may be selected. Parameters selected as shown by FIG. 4 may define categories or other aspects related to a generated view. For example and as shown by 410, gender may be selected, for example in order to view only potential mail consumers, only females or both sexes. As shown by 420, an age group may be selected. As shown by 430, a geographic location, e.g., state may be selected, as shown by 440, a life style or fields of interest parameter may be selected. As shown by 450, a product of interest, an activity or other aspect may be selected, e.g., cooking, buy a car etc. As shown by 460, historical parameter may be defined and selected. For example, it may be desirable to view only users who recently relocated to a new house so that advertising content related, for example, to furniture or gardening may be delivered to them. A view generated by embodiments of the invention, e.g., as shown by FIGS. 2 and 3 may be according to any applicable data, information, parameters, indications, rules, thresholds, criteria, settings, configuration or context. Accordingly, while only some exemplary possible selections are shown in FIGS. 2, 3 and 4, it will be recognized that any relevant parameters may be used in order to define a view as described herein.

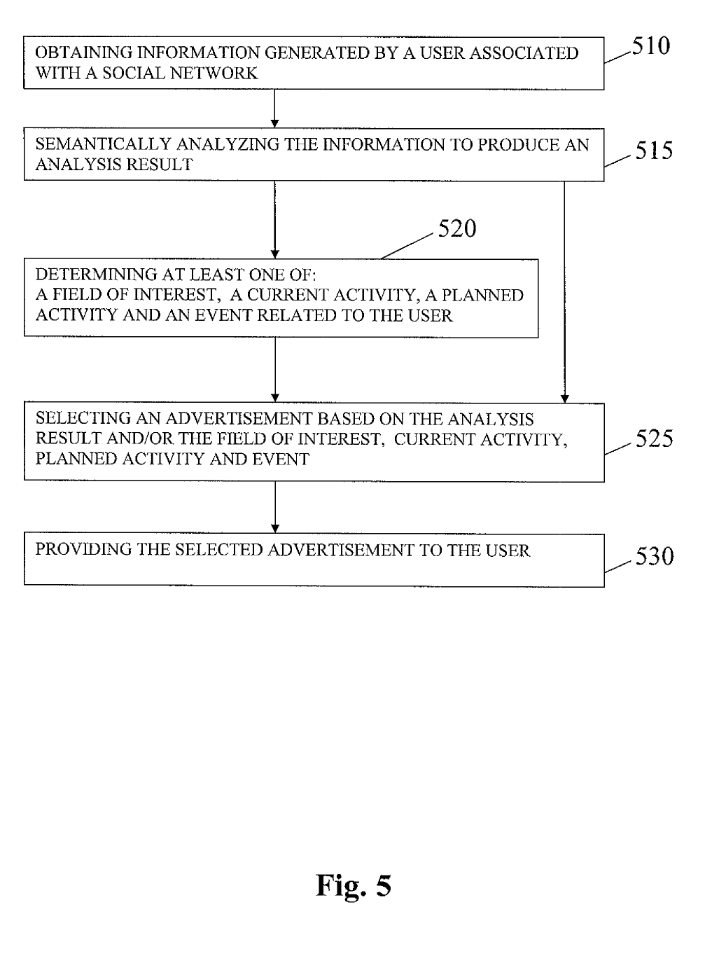

Reference is made to FIG. 5 which is an exemplary flowchart describing a method according to embodiments of the invention. As shown by block 510, the flow may include obtaining information generated by a user associated with a social network. For example, information generated by a user associated with a social network may be the content of posts or status updates generated by members of social networks as known in the art. Any other information generated by users or members of a social network may be collected or obtained and used as further described herein. Although the exemplary and simplified flow shown by FIG. 5 relates to information generated by a user, it will be understood that other information may be obtained and/or used. For example, information destined to a user, e.g., posts directed to a community of which the user is a member or a communication specifically and/or only directed to a user may likewise be obtained and used as described herein, e.g., semantically analyzed and used for selecting an advertisement. Likewise, and as described herein, information other than information exchanged between users may be obtained and used as described herein. For example, demographic data, preferences made by a user, e.g., selected by the user when creating a social networks profile or selections made by a user, e.g., using the “Like” button may all be obtained.

As shown by block 515, the flow may include semantically analyzing the information to produce an analysis result. As described herein, any analysis may be applied to obtained information in order to determine various aspects or parameters related to a user. Any additional information, data or parameters may be used in an analysis process. For example, gender, language style, citizenship or nationality, education, residence location may all be observed and/or taken into account when analyzing obtained information. Analysis as shown may be continuous or on going, e.g., performed over any applicable period, e.g., hours, days, weeks or months. Accordingly, possibly in addition to determining one or more activities performed by a user, a location of the user, relevant events and the like, a profiling of a user may be performed based on long term aspects and a user's profile may be updated and/or perfected continuously.

As shown by block 520, the flow may include determining at least one of: a field of interest, a current activity, a planned activity and an event related to the user. For example and as described herein, based on status updates, a current or planned activity of a user may be determined. Likewise, a filed of interest may be determined based on posts or status updates generated by a user.

As shown by block 525, the flow may include selecting an advertisement based on the analysis result and/or the field of interest, current activity, planned activity and event. As described herein, advertisements may be selected based on any applicable result of a semantic analysis of information generated or received by a user. For example, if it is determined that a user is interested in sports then relevant advertisements, e.g., for sports gear or game tickets may be provided to the user. In another example, an advertisement may be selected based on a current or planned activity, e.g., an advertisement for maps or a global positioning system (GPS) may be selected for a user based on his informing friends, e.g., via a status update, of a planned trip.

As shown by block 530, the flow may include providing the selected advertisement to the user. According to embodiments of the invention, once a selection of an advertisement has been made, any method or system may be used to provide the selected advertisement. For example, an advertisement server may provide a selected advertisement to a user upon receiving a selection of an advertisement and a target address (e.g., an IP address) of the user's computer.

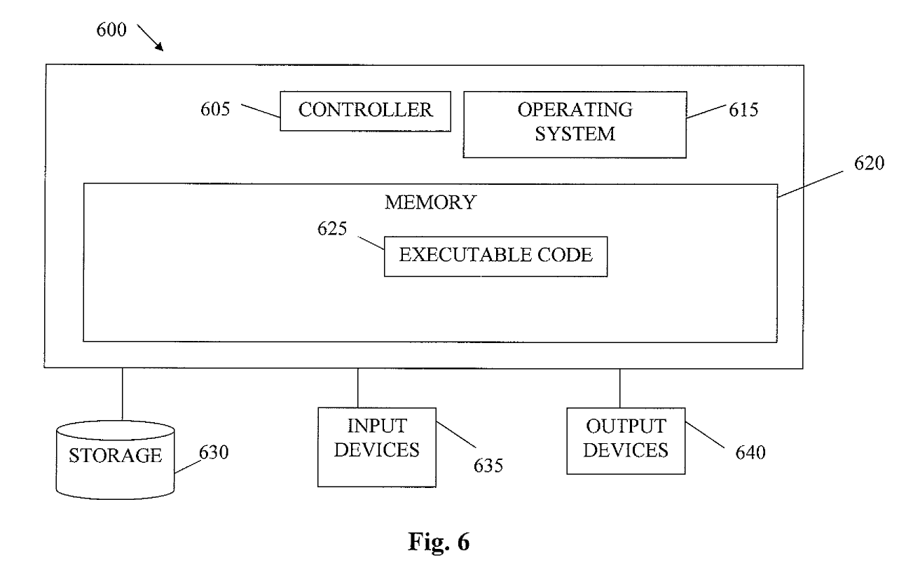

Reference is made to FIG. 6, showing high level block diagram of an exemplary computing device according to embodiments of the present invention. Computing device 600 may include a controller 605 that may be, for example, a central processing unit processor (CPU), a chip or any suitable computing or computational device, an operating system 615, a memory 620, a storage 630, an input device 635 and an output device 640.

Operating system may be or may include any code segment designed and/or configured to perform tasks involving coordination, scheduling, arbitration, supervising, controlling or otherwise managing operation of computing device 600, for example, scheduling execution of programs. Operating system 615 may be a commercial operating system. Memory 620 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 620 may be or may include a plurality of, possibly different memory units.

Executable code 625 may be any executable code, e.g., an application, a program, a process, task or script. Executable code 625 may be executed by controller 605 possibly under control of operating system 615. For example, executable code 625 may be a program or application that collects and analyzes information as described herein an further selects an advertisement as described herein. Storage 630 may be or may include, for example, a hard disk drive, a floppy disk drive, a Compact Disk (CD) drive, a CD-Recordable (CD-R) drive, a universal serial bus (USB) device or other suitable removable and/or fixed storage unit.

Input devices 635 may be or may include a mouse, a keyboard, a touch screen or pad or any suitable input device. It will be recognized that any suitable number of input devices may be operatively connected to computing device 600 as shown by block 635. Output devices 640 may include one or more displays, speakers and/or any other suitable output devices. It will be recognized that any suitable number of output devices may be operatively connected to computing device 600 as shown by block 640. Any applicable input/output (I/O) devices may be connected to computing device 600 as shown by blocks 635 and 640. For example, a network interface card (NIC), a printer or facsimile machine, a universal serial bus (USB) device or external hard drive may be included in input devices 635 and/or output devices 640. According to embodiments of the invention, computing devices operated by users A, b and C shown in FIG. 1 may comprise all or some of the components comprised in computing device 600 as shown and described herein.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein. For example, a storage medium such as memory 620, computer-executable instructions such as executable code 625 and a controller such as controller 605. Some embodiments may be provided in a computer program product that may include a machine-readable medium, stored thereon instructions, which may be used to program a computer, or other programmable devices, to perform methods as disclosed above.

It will be recognized that embodiments of the present invention may work together with ad servers. For example, the system of the present invention may identify one or more categories of suitable advertisements, and convey this information to a suitable ad server for selection of specific advertisements based thereon. For example, in some embodiments, or in some cases, a specific advertisement may be selected and served to one or more users, which may be retrieved by direct reference, e.g., by direct reference to a file server such as an ad server. In such embodiments or cases, advertisement selection may comprise selecting a category, criteria, or other parameters, rather than a particular advertisement. For example, an advertisement server may receive from an embodiment of the invention the parameter such as a category, and may select a particular advertisement to be served based at least in part on that parameter or category. For example, an embodiment of the invention may determine, based on an analysis as described herein that an advertisement for a vacation in Italy should to be served. This information may be provided to an ad server, which may store advertisements and which may select an advertisement about Italy and/or serve the advertisement based on this information. It will be recognized that a decision of which ad server to reference for serving the advertisement may be made based on any method, for example, based on the highest bidder for providing advertisements in particular categories.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of semantic based advertising, the method comprising:
providing to a processor digital information generated by a user associated with a social related platform;
semantically analyzing, by said processor, said digital information to produce an analysis result;
selecting an advertisement based on said analysis result; and
providing said advertisement to said user.

2. The method of claim 1, wherein said digital information is obtained from a communication selected from the list consisting of: posts, status updates and emails.

3. The method of claim 1, comprising determining a current activity of said user based on said analysis result.

4. The method of claim 1, wherein said providing said digital information, analyzing said digital information and selecting and providing said advertisement are performed in realtime.

5. The method of claim 1, wherein said analysis comprises at least one of text analysis, word spotting and analyzing word combinations.

6. The method of claim 1, wherein said analysis is based on a language style associated with said user.

7. The method of claim 1, comprising determining a field of interest related to said user based on said analysis and selecting said advertisement based on said field of interest.

8. The method of claim 1, comprising associating said user with a predefined category based on said analysis result and selecting said advertisement based on said category.

9. The method of claim 1, comprising determining a planned activity related to said user based on said analysis and selecting said advertisement based on said planned activity.

10. The method of claim 1, comprising determining an event related to said user based on said analysis and selecting said advertisement based on said event.

11. The method of claim 1, comprising performing semantic analysis of a web page associated with said social network and selecting said advertisement based on said semantic analysis of said web page.

12. The method of claim 1, comprising updating a user profile based on said analysis result and selecting said advertisement based on information included in said user profile.

13. The method of claim 12, comprising:
updating said user profile according to a long term related parameter;
updating a second user profile based on a realtime related parameter; and
selecting said advertisement based on information included in said user profile and said second user profile.

14. The method of claim 12, comprising relating said user profile to a second user profile associated with a second user and, based on said relating, selecting to provide said advertisement to said second user.

15. The method of claim 1, comprising:
obtaining digital information generated by a second user associated with said social network;
semantically analyzing said digital information to produce a second analysis result;
updating a social network profile based on said analysis result and said second analysis result;
selecting an advertisement based on said social network profile; and
providing said advertisement to at least one member of said social network.

16. The method of claim 15, comprising determining an activity related to said social network and selecting said advertisement based on said activity.

17. The method of claim 15, comprising determining a field of interest related to said social network and selecting said advertisement based on said field of interest.

18. The method of claim 15, comprising determining a planned activity related to said social network and selecting said advertisement based on said planned activity.

19. The method of claim 15, wherein said selecting an advertisement based on said profile is performed in realtime.

20. The method of claim 1, wherein said social related platform is selected from the list comprising: Twitter, myspace, Facebook, LinkedIn, gmail and hotmail.
